(19) United States
(12) Patent Application Publication
(10) Pub. No.: US 2013/0223735 A1
(43) Pub. Date: Aug. 29, 2013

(54) METHOD AND APPARATUS FOR ELIMINATING CHROMATIC ABERRATION

(71) Applicants: Chih-Yuan Yang, Hsinchu County (TW); Yi-Wen Yuen, Hsinchu City (TW); Meng-Ting Lin, Taipei City (TW)

(72) Inventors: Chih-Yuan Yang, Hsinchu County (TW); Yi-Wen Yuen, Hsinchu City (TW); Meng-Ting Lin, Taipei City (TW)

(73) Assignee: NOVATEK MICROELECTRONICS CORP., Hsinchu (TW)

(21) Appl. No.: 13/457,511

(22) Filed: Apr. 27, 2012

(30) Foreign Application Priority Data
Feb. 23, 2012 (TW) 101106068

(51) Int. Cl. G06K 9/40

(52) U.S. Cl. 382/167

(57) ABSTRACT

A method and an apparatus for eliminating chromatic aberration are provided. The method includes: calculating out a position weight of a pixel according to the position of the pixel in an image, calculating out an edge response of the pixel and converting a chrominance of the image pixel into a hue; using the edge response of the pixel to calculate out a hue range; and finally correcting the hue of the image pixel by using the position weight, the edge response and/or the hue range.

### CROSS-REFERENCE TO RELATED APPLICATION

This application claims the priority benefit of Taiwan application serial no. 101106068, filed on Feb. 23, 2012. The entirety of the above-mentioned patent application is hereby incorporated by reference herein and made a part of this specification.

### BACKGROUND OF THE INVENTION

1. Field of the Invention

The invention generally relates to an electronic apparatus, and more particularly, to a method and an apparatus for eliminating image chromatic aberration.

2. Description of Related Art

The development of science and technology makes the volumes of the optical components of image-capturing devices increasingly smaller. The image chromatic aberration of an image-capturing device is a chromatic aberration phenomenon produced by light via different image height positions of optical lens. In the prior art, in order to eliminate the chromatic aberration phenomenon, a combination of multiple lenses is used; however, such a conventional scheme requires to revise the optical design of the set of lenses and hence increases the cost of the set of lenses.

### SUMMARY OF THE INVENTION

Accordingly, a method and an apparatus are disclosed for eliminating chromatic aberration able to effectively eliminate/reduce the image chromatic aberration.

In an aspect, a method for eliminating chromatic aberration is provided, which includes calculating a position weight of a pixel according to the position of the pixel in an image, and correcting the original chrominance of the pixel by using the position weight.

In another aspect, a method for eliminating chromatic aberration is provided, comprising calculating a position weight of a pixel according to relative distance between the pixel and center coordinates of an image, calculating an edge response of the pixel according to a luminance of the image, converting the edge response into a hue range, and converting the chrominance of the pixel into a hue, and correcting original chrominance of the pixel by using the edge response, the hue, the hue range and position weight.

In further another aspect, an apparatus for eliminating chromatic aberration is provided, which includes a position weight calculation unit and a chrominance correction unit. The position weight calculation unit receives the data of the pixel and calculates a position weight of the pixel according to the position of the pixel in an image. The chrominance correction unit is coupled to the position weight calculation unit, in which the chrominance correction unit corrects the original chrominance of the pixel by using the position weight.

Based on the description above, the position weight calculation unit in the embodiment of the invention calculates the position weight of the pixel according to the position of the pixel in the image and the chrominance correction unit uses the position weight to correct the original chrominance of the pixel. In this way, the embodiment of the invention can effectively eliminate/reduce the image chromatic aberration without revising the optical design of the set of lenses.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a schematic block diagram of an apparatus for eliminating chromatic aberration according to an embodiment of the invention.

FIG. 2 is a schematic flowchart of a method for eliminating chromatic aberration according to an embodiment of the invention.

FIG. 3 is a diagram showing the position of a pixel in an image according to one of embodiments of the invention.

FIG. 4 is a schematic block diagram of an apparatus for eliminating chromatic aberration 400 according to another embodiment of the invention.

FIG. 5 is a diagram illustrating the relationship between the luminance Y of the image and the edge response (I_{P} or I_{N}) thereof according to an embodiment of the invention.

FIG. 6 is a schematic flowchart of a method for eliminating chromatic aberration according to another embodiment of the invention.

FIG. 7 is two plots of the converting curves between the edge response of pixel and the edge response weight according to an embodiment of the invention.

FIG. 8 is a schematic block diagram of an apparatus for eliminating chromatic aberration according to yet another embodiment of the invention.

FIG. 9 is a schematic flowchart of a method for eliminating chromatic aberration according to yet another embodiment of the invention.

FIG. 10 is a hue domain plot according to an embodiment of the invention.

### DESCRIPTION OF THE EMBODIMENTS

In following embodiments, three characteristics causing the optical chromatic aberration are considered for performing the optical correction. The first characteristic is that the extent of chromatic aberration is roughly positively proportional to the deviated distance of a pixel position from the optical center in the image. The second characteristic is that the chromatic aberration mostly occurs at places where the contrasts of adjacent pixels are dramatically changed, for example, at image detail edges. The third characteristic is that the chromatic aberrations at a positive edge and a negative edge of an image detail edge have different chromatic performances. The following embodiments are related to the eliminating chromatic aberration respectively according to one or more of the three characteristics and moreover make accurate estimation to ensure the image quality not degraded. For example, in an embodiment, only the first characteristic is considered for performing optical correction, while in other embodiments, the first to third characteristics are all considered for performing optical correction. It should be noted that in different embodiments, to eliminate the chromatic aberration, several different combinations of the first to third characteristics can be considered, and the invention is not limited to the following embodiments.

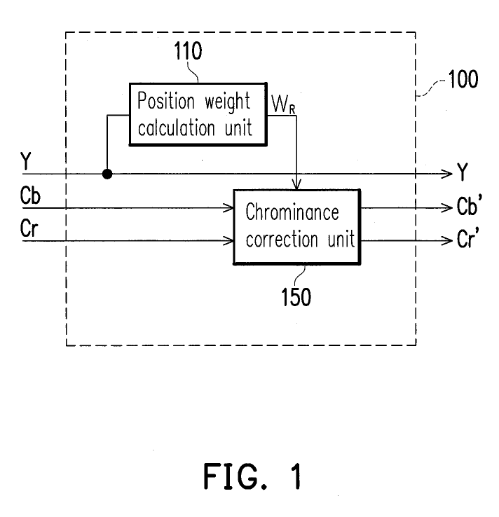

FIG. 1 is a schematic block diagram of an apparatus for eliminating chromatic aberration 100 according to an embodiment of the invention. Referring to FIG. 1, the apparatus for eliminating chromatic aberration 100 includes a position weight calculation unit 110 and a chrominance correction unit 150. The chrominance correction unit 150 is coupled to the position weight calculation unit 110.

The apparatus for eliminating chromatic aberration 100 can be applied in any image shooting/capturing/processing system. For example, the apparatus for eliminating chromatic aberration 100 can be used in a digital camera or a video camera. The data of an image can be obtained by sampling the image through a set of lenses and an image sensor. The data of the image is provided to the apparatus for eliminating or reducing chromatic aberration 100 through an image processing circuit and/or a transmission circuit. In the embodiment, the data of the image received by the apparatus for eliminating or reducing chromatic aberration 100 includes, but not limited to, a luminance Y, a chroma component Cb and a chroma component Cr. For example, in another embodiment, the data of the image can contain a red data R, a green data G and a blue data B. In further other embodiments, the data of the image can contain saturation data and hue data.

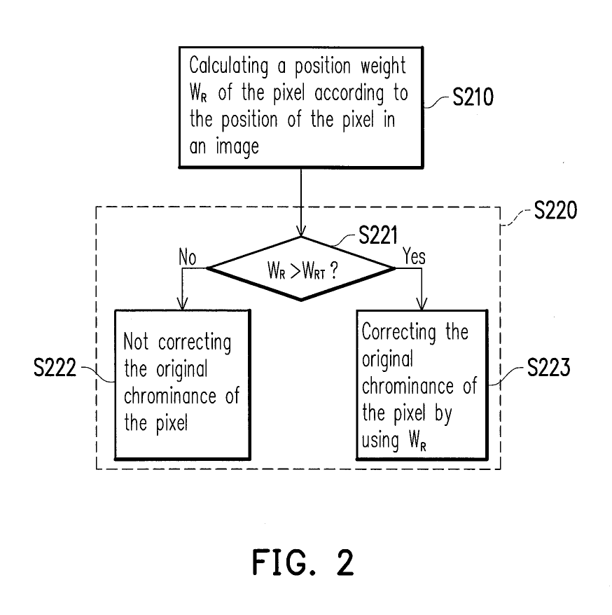

FIG. 2 is a schematic flowchart of a method for eliminating chromatic aberration according to an embodiment of the invention. Referring to FIGS. 1 and 2, the position weight calculation unit 110 receives the data of a pixel and calculates a position weight W_{R} of the pixel according to the position of the pixel in an image (step S210). The chrominance correction unit 150 uses the position weight W_{R} to correct the original chrominance of the pixel (step S220). In FIG. 1, the original chrominance of the pixel contains a chroma component Cb and a chroma component Cr. After step S220, the chrominance correction unit 150 outputs a new chrominance which contains a new chroma component Cb′ and a new chroma component Cr′.

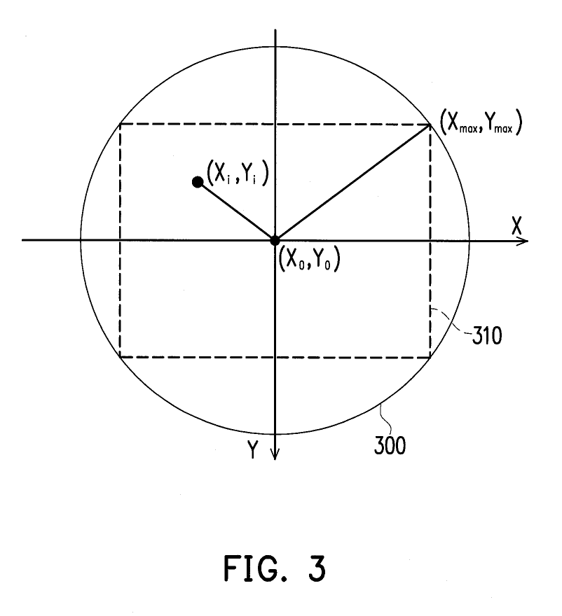

FIG. 3 is a diagram showing the position of a pixel in an image according to one of embodiments of the invention. Referring to FIG. 3, a circle 300 herein represents an imageable range of optical lens, and X₀, Y₀ are center coordinates of the image. A hidden line frame 310 herein represents the maximal range of image frame able for sampling, and Xₘₐₓ and Yₘₐₓ are the coordinate positions corresponding to the greatest image height. In other words, if the hidden line frame 310 represents the image, Xₘₐₓ is the maximal value among the X-axis of the image and Yₘₐₓ is the maximal value among the Y-axis of the image. The coordinates of a pixel in the image 310 are Xᵢ and Yᵢ. Step S210 shown by FIG. 2 in the embodiment includes using Formula 1 to calculate the position weight W_{R}:

W_{R}=[(Xᵢ−X₀)²+(Yᵢ−Y₀)²]/[Xₘₐₓ−X₀)²+(Yₘₐₓ−Y₀)²] Formula 1

It can be seen from Formula 1 that the position weight W_{R} is just the ratio of the distance between the position Xᵢ and Yᵢ of the pixel and the image center (X₀, Y₀) over the distance between the image height (Xₘₐₓ, Yₘₐₓ) and the image center (X₀, Y₀). In step S210, the position weight calculation unit 110 can use formula 1 to calculates out the position weight W_{R} and then transmit the position weight W_{R} to the chrominance correction unit 150.

The chromatic aberration phenomenon is mainly caused by a set of lenses in an image-capturing device and usually occurs at the surrounding range with higher image heights but farther distances from the lens center (X₀, Y₀), for example, at places nearby the edge of the circle 300 shown by FIG. 3. Hence in the embodiment, the position weight W_{R} is positively proportional to the distance between the position Xᵢ and Yᵢ of pixel and the image center (X₀, Y₀). In other words, if a position Xᵢ and Yᵢ of pixel is located at the image center (X₀, Y₀) with image height ‘0’, the position weight W_{R} takes the minimal value; if a position Xᵢ and Yᵢ of pixel ie located at the peripheral with the greatest image height, for example, at (Xₘₐₓ, Yₘₐₓ), the position weight W_{R} takes the maximal value. It should be noted that other schemes for adjusting the position weight W_{R} according to the distance between the position Xᵢ and Yᵢ of the pixel and the image center (X₀, Y₀), i.e., the ones not limited by Formula 1, are allowed by the invention. However the position weight W_{R} is preferably arranged to ascend along with the ascending distance between the position Xᵢ and Yᵢ of the pixel and the image center (X₀, Y₀).

The chrominance correction unit 150 can correct the original chrominance of the pixel (i.e., chroma component Cb and chroma component Cr) according to the position weight W_{R}. For example, regardless of what value the position weight W_{R} is, in step S220, Formulas 2 and 3 are used to calculate new chroma component Cb′ and new chroma component Cr′:

Cb′=Cb×W_{R}×W_{NORMAL} Formula 2

Cr′=Cr×W_{R}×W_{NORMAL} Formula 3

W_{NORMAL} herein is a normalized parameter, which can be any real number. In implementations of the embodiment, the value of the normalized parameter W_{NORMAL} can be decided according to real design requirements of products. In another embodiment, for example, regardless of what value the position weight W_{R} is, in step S220, Formulas 4 and 5 are used to calculate new chroma component Cb′ and new chroma component Cr′:

Cb′=Cb×W_{NORMAL}÷W_{R} Formula 4

Cr′=Cr×W_{NORMAL}÷W_{R} Formula 5

The implementation of the embodiment can be others and not limited to the description above. At the time, for example, the chrominance correction unit 150 can first check up the distance between the position (Xᵢ, Yᵢ) of the pixel and the image center (X₀, Y₀). If the distance between the position (Xᵢ, Yᵢ) of the pixel and the image center (X₀, Y₀) is greater than a predetermined distance, then, the chrominance correction unit 150 calculates the new chroma component Cb′ and the new chroma component Cr′ by using Formulas 2 and 3 (or Formulas 4 and 5). If the distance between the position (Xᵢ, Yᵢ) of the pixel and the image center (X₀, Y₀) is less than a predetermined distance, then, the chrominance correction unit 150 does not correct the original chrominance of the pixel, i.e., Cb′=Cb and Cr′=Cr.

In the embodiment, step S220 in FIG. 2 includes sub-steps S221-S223. The chrominance correction unit 150 has defined a position weight threshold W_{RT} therein. When finishing step S210, the chrominance correction unit 150 conducts sub-step S221 to compare the position weight W_{R} with the position weight threshold W_{RT} followed by deciding whether to correct the original chrominance of the pixel according to the comparison result. Preferably as shown by FIG. 2, if the position weight W_{R} is less than the position weight threshold W_{RT}, the chrominance correction unit 150 does not correct the original chrominance of the pixel (sub-step S222), i.e., Cb′=Cb and Cr′=Cr. If the position weight W_{R} is greater than the position weight threshold W_{RT} according to the judgement of the chrominance correction unit 150, the chrominance correction unit 150 calculates the new chroma component Cb′ and the new chroma component Cr′ so as to correct the original chrominance of the pixel by using Formulas 2 and 3 (or Formulas 4 and 5). (sub-step S223)

Since the position weight calculation unit 110 in the embodiment calculates out the position weight W_{R} of the pixel according to the position of the pixel in the image and the chrominance correction unit 150 can correct the original chrominance of the pixel (Cb and Cr) by using the position weight W_{R}, so that the embodiment has no need to revise the optical design of the set of lenses to effectively eliminate/reduce the image chromatic aberration.

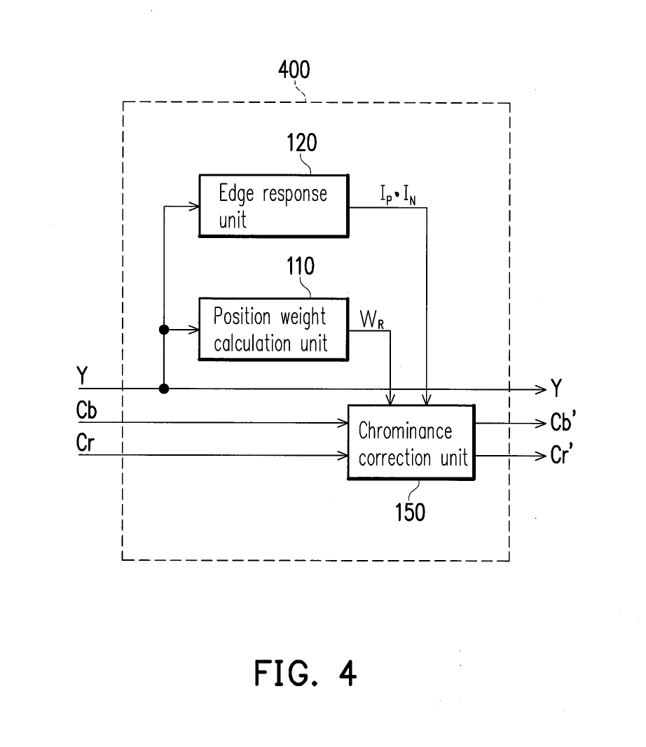

FIG. 4 is a schematic block diagram of an apparatus for eliminating chromatic aberration 400 according to another embodiment of the invention. The apparatus for eliminating chromatic aberration 400 in FIG. 4 can refer to the related descriptions of the apparatus for eliminating chromatic aberration 100 in FIGS. 1, 2 and 3. The difference from the apparatus for eliminating chromatic aberration 100 of FIG. 1 lies in that the apparatus for eliminating chromatic aberration 400 of FIG. 4 further includes an edge response unit 120. As previously pointed, the three characteristics are main causes of the optical chromatic aberration. The first characteristic is that the extent of chromatic aberration is roughly positively proportional to the deviated distance of a pixel position (Xᵢ, Yᵢ) from the optical center (X₀, Y₀) in the image. The second characteristic is that the chromatic aberration mostly occurs at places where the contrasts of adjacent pixels are dramatically changed, for example, at image detail edges. The third characteristic is that the chromatic aberrations at the positive edge and the negative edge of an image detail edge have different chromatic performances. The embodiment would follow the three characteristics to eliminate or reduce chromatic aberration and moreover to make correct estimation to ensure the image quality not degraded.

The edge response unit 120, coupled to the chrominance correction unit 150, can receive the data of the pixel and calculate the edge response of the pixel according to the luminance Y of the image. In the embodiment, the edge response may be a positive detail intensity response I_{P} or a negative detail intensity response I_{N}. The edge response unit 120 can adopt a filter, and preferably for example, a second-order differential filter or a Laplacian filter, to perform a detail intensity calculation on the luminance Y of the image so as to further obtain the positive detail intensity response I_{P} or the negative detail intensity response I_{N}. After that, the positive detail intensity response I_{P} or the negative detail intensity response I_{N} is output to the chrominance correction unit 150, in which the chrominance correction unit 150 further uses the edge response (I_{P} or I_{N}) or the position weight W_{R} to correct the original chrominance of the pixel.

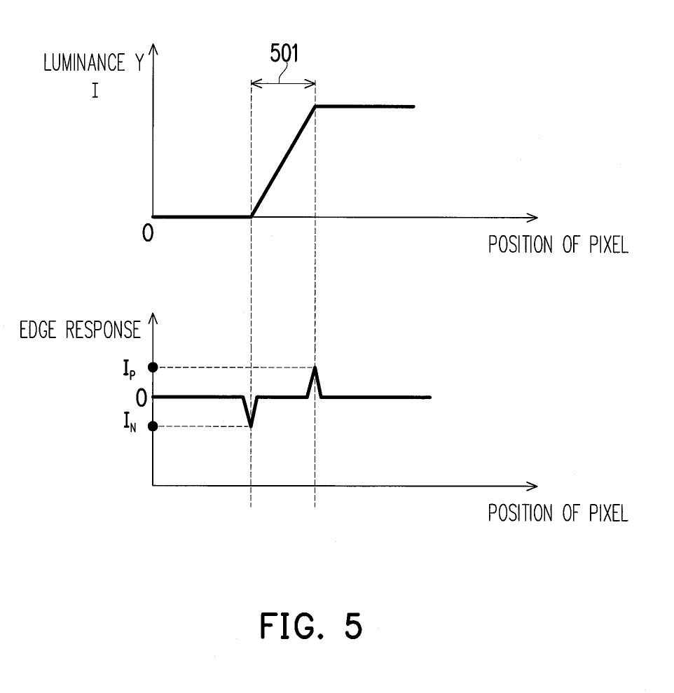

FIG. 5 is a diagram illustrating the relationship between the luminance Y of the image and the edge response (I_{P} or I_{N}) thereof according to an embodiment of the invention. At the upper part of FIG. 5, the luminance variation corresponding to different pixel positions in the image 310 (referring to FIG. 3) is given, in which the ordinate represents luminance Y and the abscissa represents pixel position. At the lower part of FIG. 5, the output of the edge response unit 120 is given, in which the ordinate represents luminance Y and the abscissa represents pixel position. In the embodiment, there is an image detail edge at a position interval 501 of the image 310, so that the output of the edge response unit 120 has a positive pulse and a negative pulse at both ends of the position interval 501. If the edge response intensity produced by the edge response unit 120 is greater than ‘0’, the edge response is called as positive detail intensity response I_{P}; otherwise, if the edge response intensity produced by the edge response unit 120 is less than ‘0’, the edge response is called as negative detail intensity response I_{N}. The detail intensity response is mainly used to detect the dramatic contrast extent of adjacent pixels.

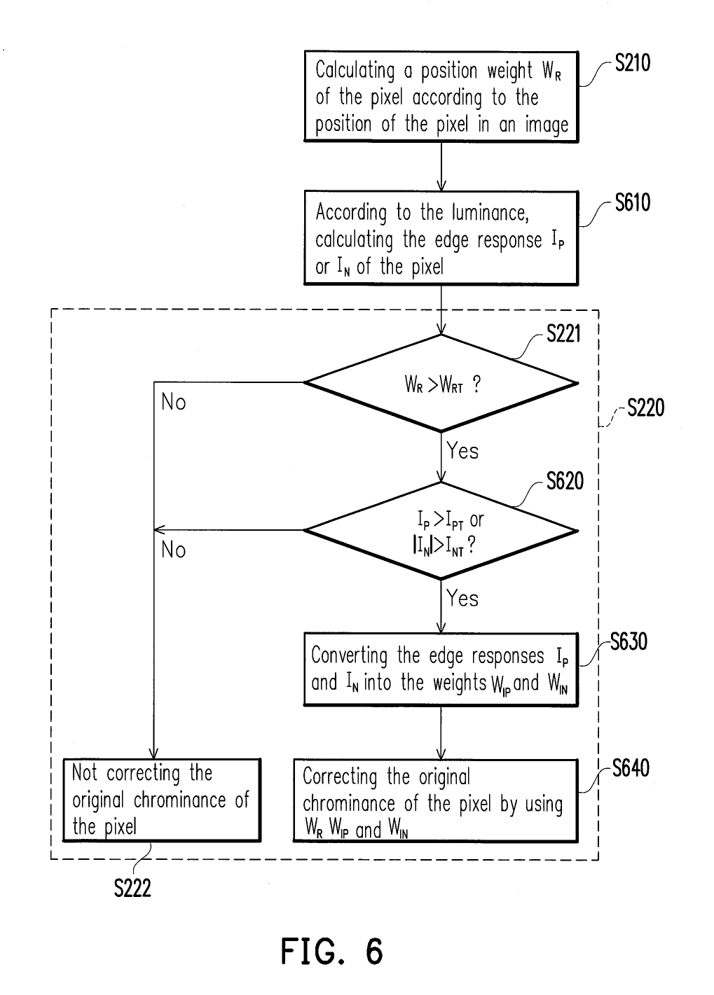

FIG. 6 is a schematic flowchart of a method for eliminating chromatic aberration according to another embodiment of the invention. The embodiment of FIG. 6 can refer to the related descriptions of FIG. 2. The difference from the embodiment of FIG. 2 rests in the embodiment of FIG. 6 further includes step S610 and step S220 further includes sub-steps S620, S630 and S640. Referring to FIGS. 4 and 6, after finishing step S210 (after calculating out the position weight W_{R}), the edge response unit 120 conducts step S610 to calculate the edge response of the pixel according to the luminance Y of the image. The edge response of the pixel may be the positive detail intensity response I_{P} or the negative detail intensity response I_{N}.

The chrominance correction unit 150 further uses the edge response (I_{P} or I_{N}) and the position weight W_{R} to correct the original chrominance of the pixel. In the embodiment, the chrominance correction unit 150 has defined a position weight threshold W_{RT}, a positive detail intensity response threshold I_{PT} and a negative detail intensity response threshold I_{NT} therein. After finishing step S610, the chrominance correction unit 150 conducts sub-step S221 to compare the position weight W_{R} with the position weight threshold W_{RT}. If the position weight W_{R} is less than the position weight threshold W_{RT}, the chrominance correction unit 150 does not correct the original chrominance of the pixel (sub-step S222), i.e., Cb′=Cb and Cr′=Cr. If the position weight W_{R} is greater than the position weight threshold W_{RT} according to the judgement of the chrominance correction unit 150, the chrominance correction unit 150 conducts sub-step S620.

In sub-step S620, the chrominance correction unit 150 compares the positive detail intensity response I_{P} with the positive detail intensity response threshold I_{PT} or compares the absolute value of the negative detail intensity response I_{N} with the negative detail intensity response threshold I_{NT} and then decides whether to correct the original chrominance of the pixel according to the comparison result. Preferably, if the edge response of the pixel is the positive detail intensity response I_{P}, the chrominance correction unit 150 compares the positive detail intensity response Iₚ with the positive detail intensity response threshold I_{PT}; if the edge response of the pixel is the negative detail intensity response I_{N}, the chrominance correction unit 150 compares the absolute value of the negative detail intensity response I_{N} with the negative detail intensity response threshold I_{NT}. If the positive detail intensity response I_{P} is less than the positive detail intensity response threshold I_{PT} (or the absolute value of the negative detail intensity response I_{N} is less than the negative detail intensity response threshold I_{NT}), the chrominance correction unit 150 does not correct the original chrominance of the pixel (sub-step S222). If the positive detail intensity response I_{P} is greater than the positive detail intensity response threshold I_{PT} (or the absolute value of the negative detail intensity response I_{N} is greater than the negative detail intensity response threshold I_{NT}) according to the judgement of the chrominance correction unit 150, the chrominance correction unit 150 conducts sub-step S630.

In sub-step S630, the chrominance correction unit 150 converts the edge response of the pixel into an edge response weight. If the edge response of the pixel is a positive detail intensity response I_{P}, the chrominance correction unit 150 converts the positive detail intensity response I_{P} into a positive detail intensity response weight W_{IP}. If the edge response of the pixel is a negative detail intensity response I_{N}, the chrominance correction unit 150 converts the negative detail intensity response I_{N} into a negative detail intensity response weight W_{IN}. The conversion between the edge response and the edge response weight depends on the real product design. The chrominance correction unit 150 can use the formulas, the conversion curves, the LUT (lookup table) or other ways to convert the edge response of the pixel into the edge response weight.

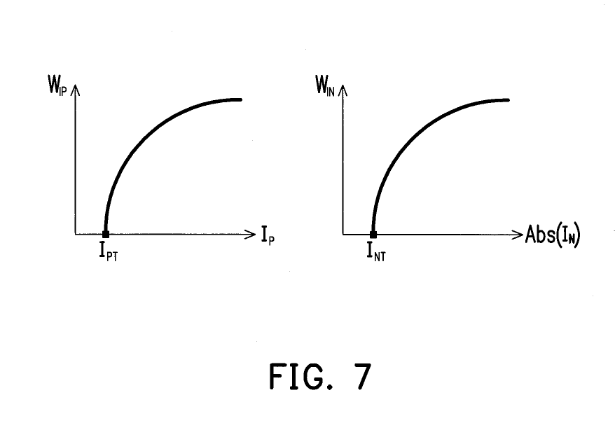

For example, the conversion can use FIG. 7 to implement. FIG. 7 is two plots of the converting curves between the edge response of pixel and the edge response weight in the image 310 (referring to FIG. 3) according to an embodiment of the invention. At the left part of FIG. 7, a curve between the positive detail intensity response I_{P} and the positive detail intensity response weight W_{IP} is given, in which the ordinate represents positive detail intensity response weight W_{IP} and the abscissa represents positive detail intensity response I_{P}. At the right part of FIG. 7, a curve between the negative detail intensity response I_{N} and the negative detail intensity response weight W_{IN} is given, in which the ordinate represents negative detail intensity response weight W_{IN} and the abscissa represents negative detail intensity response I_{N}. The chrominance correction unit 150 can convert the edge response (I_{P} or I_{N}) into the edge response weight (W_{IP} or W_{IN}) according to the conversion curves of FIG. 7.

Continuing to FIG. 6 again, the detail intensity response is mainly used to detect the dramatic contrast extent of adjacent pixels. When the position weight W_{R} is larger and the detail edge response I_{P} and the absolute value of I_{N} are respectively greater than a positive detail intensity response threshold I_{PT} and a negative detail intensity response threshold I_{NT}, it indicates a more significant chromatic aberration suppression must be conducted on the pixel at the position, so that sub-step S630 produces the edge response weights (W_{IP} and W_{IN}) representing the detail edge responses I_{P} and I_{N}. If the position weight W_{R} is greater than the position weight threshold W_{RT} and the positive detail intensity response I_{P} is greater than the positive detail intensity response threshold I_{PT} (the absolute value of the negative detail intensity response I_{N} is greater than the negative detail intensity response threshold I_{NT}), the chrominance correction unit 150 conducts sub-step S640 to correct the original chrominance of the pixel.

If the edge response of the pixel is the positive detail intensity response I_{P}, in sub-step S640, the chrominance correction unit 150 can use Formulas 6 and 7 to calculate the new chroma component Cb′ and the new chroma component Cr′:

Cb′=Cb×(W_{R}+W_{IP})×W_{NORMAL} Formula 6

Cr′=Cr×(W_{R}+W_{IP})×W_{NORMAL} Formula 7

W_{NORMAL} herein is a normalized parameter, which can be any real number. All users of the embodiment can decide the value of the normalized parameter W_{NORMAL} according to the real product design. If the edge response of the pixel is the negative detail intensity response I_{N}, in sub-step S640, the chrominance correction unit 150 can use Formulas 8 and 9 to calculate the new chroma component Cb′ and the new chroma component Cr′:

Cb′=Cb×(W_{R}+W_{IN})×W_{NORMAL} Formula 8

Cr′=Cr×(W_{R}+W_{IN})×W_{NORMAL} Formula 9

In another embodiment, for example, if the edge response of the pixel is the positive detail intensity response I_{P}, in sub-step S640, the chrominance correction unit 150 can use Formulas 10 and 11 to calculate the new chroma component Cb′ and the new chroma component Cr′:

Cb′=Cb×W_{NORMAL}÷(W_{R}+W_{IP}) Formula 10

Cr′=Cr×W_{NORMAL}÷(W_{R}+W_{IP}) Formula 11

If the edge response of the pixel is the negative detail intensity response I_{N}, in sub-step S640, the chrominance correction unit 150 can use Formulas 12 and 13 to calculate the new chroma component Cb′ and the new chroma component Cr′:

Cb′=Cb×W_{NORMAL}÷(W_{R}+W_{IN}) Formula 12

Cr′=Cr×W_{NORMAL}÷(W_{R}+W_{IN}) Formula 13

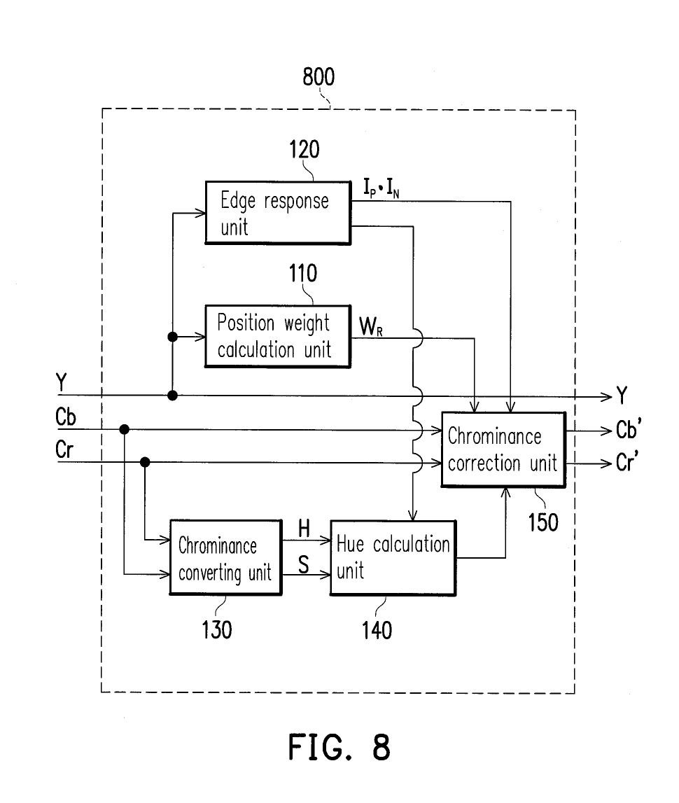

FIG. 8 is a schematic block diagram of an apparatus for eliminating chromatic aberration 800 according to yet another embodiment of the invention. The apparatus for eliminating chromatic aberration 800 in FIG. 8 can refer to the related descriptions of the apparatus for eliminating chromatic aberration 100 in FIGS. 1, 2 and 3 and the related descriptions of the apparatus for eliminating chromatic aberration 400 in FIGS. 4, 5, 6 and 7. The difference from the apparatus for eliminating chromatic aberration 400 of FIG. 4 rests in the apparatus for eliminating chromatic aberration 800 of FIG. 8 further includes a chrominance converting unit 130 and a hue calculation unit 140.

Referring to FIG. 8, the edge response unit 120 can adopt a filter (such as a second-order differential filter or a Laplacian filter) to receive luminance of all pixels from outside to calculate the positive detail intensity responses and the negative detail intensity responses of all the pixels, followed by transmitting the positive detail intensity response I_{P} and the negative detail intensity response I_{N} to the hue calculation unit 140 and the chrominance correction unit 150.

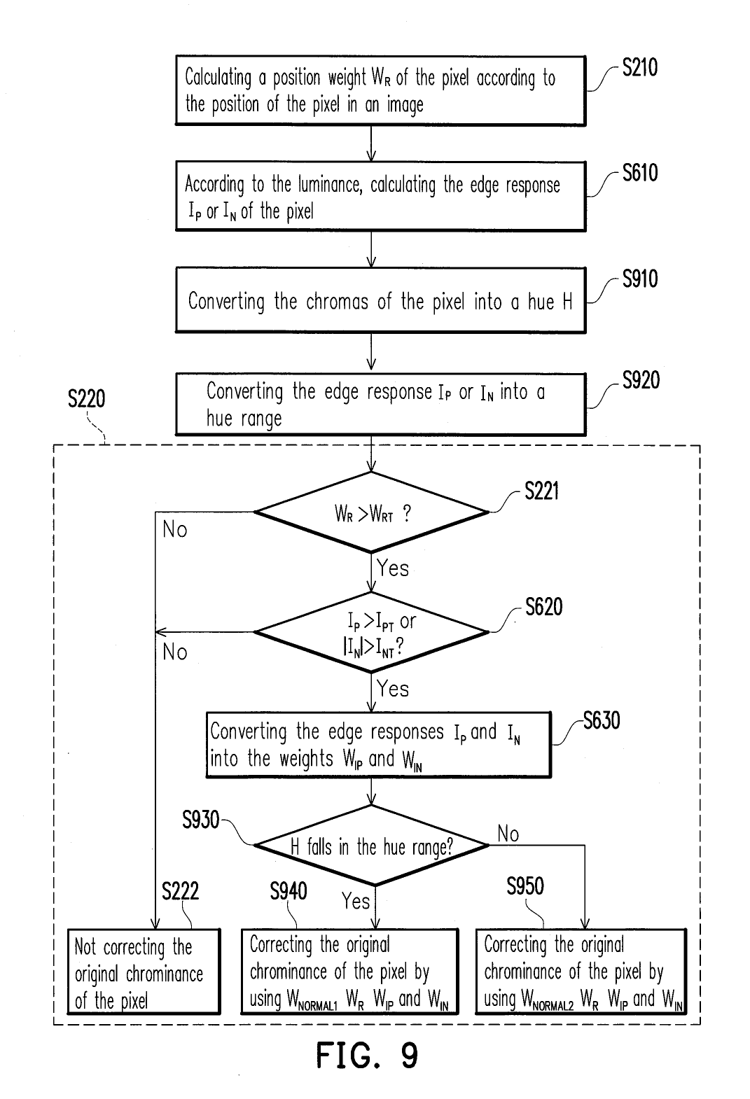

FIG. 9 is a schematic flowchart of a method for eliminating chromatic aberration according to yet another embodiment of the invention. The embodiment of FIG. 9 can refer to the related descriptions of FIGS. 2 and 6 and the difference from the embodiment of FIG. 6 lies in that the embodiment of FIG. 9 further includes steps S910 and S920, and the step S220 includes sub-steps S930, S940 and S950. Referring to FIGS. 8 and 9, after step S610, the chrominance converting unit 130 conducts step S910 to receive the data of the pixel and converts the chroma component Cb and chroma component Cr of the pixel into a hue H and a saturation S, in which the hue H represents chromatic angle of the pixel and saturation S represents chromatic depth of the pixel. The chrominance converting unit 130 can use Formulas 14 and 15 to calculate the hue H and the saturation S:

H=arctan(Cb/Cr) Formula 14

S=sqrt(Cb²/Cr²) Formula 15

In the above-mentioned formulas, arctan( ) represents arctangent function, while the sqrt( ) represents square root function. The hue calculation unit 140 is coupled to the chrominance converting unit 130 and the chrominance correction unit 150. The hue calculation unit 140 converts the edge response (I_{P} or I_{N}) provided by the edge response unit 120 into a hue range (step S920), followed by transmitting the hue range and the hue H provided by the chrominance converting unit 130 to the chrominance correction unit 150. In the embodiment, the hue calculation unit 140 includes an LUT of hue range, as shown by Table 1:

TABLE 1
LUT of hue range

| Edge response value | Hue value | Hue difference |
|---|---|---|
| I_{P} | H_{P} | ΔH_{P} |
| I_{N} | H_{N} | ΔH_{N} |
| . . . | . . . | . . . |

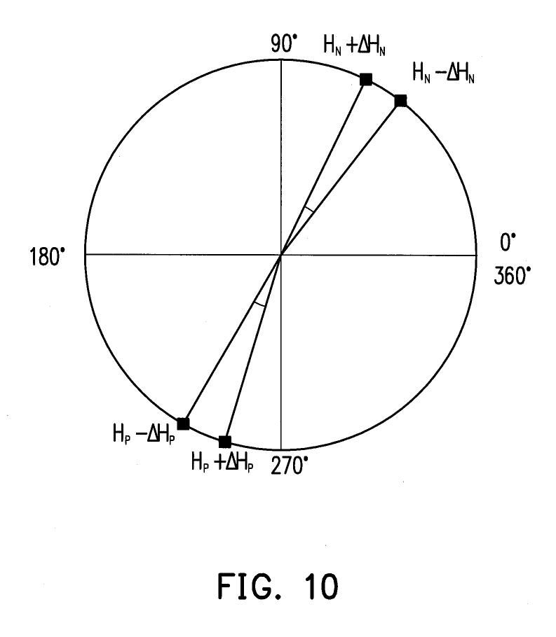

H_{P} herein represents hue of the chromatic aberration on the positive detail intensity response I_{P}, H_{N} represents hue of the chromatic aberration on the negative detail intensity response I_{N}, ΔH_{P} represents allowed hue difference on the positive detail intensity response I_{P} and ΔH_{N} represents allowed hue difference on the negative detail intensity response I_{N}. The hue calculation unit 140 can find out the corresponding hue range in the LUT of hue range according to the edge response (I_{P} or I_{N} or other values). In the embodiment, the hue range is defined by hue value and hue difference. For example, the hue range is between (hue value+hue difference) and (hue value−hue difference). FIG. 10 is a hue domain plot according to an embodiment of the invention. If the hue value is H_{P} and the hue difference is ΔH_{P}, the hue range is between (H_{P}+ΔH_{P}) and (H_{P}−ΔH_{P}). If the hue value is H_{N} and the hue difference is ΔH_{N}, the hue range is between (H_{N}+ΔH_{N}) and (H_{N}−ΔH_{N}). After step S920, the chrominance correction unit 150 conducts step S220 to correct the original chrominance of the pixel (for example, Cb and Cr) by using the edge response (I_{P} or I_{N}), the hue H, the hue range and the position weight W_{R}.

The chrominance correction unit 150 defines the position weight threshold W_{RT}, the positive detail intensity response threshold I_{PT} and the negative detail intensity response threshold I_{NT}. In sub-step S221, the chrominance correction unit 150 compares the position weight W_{R} with the position weight threshold W_{RT}, and in sub-step S620, the chrominance correction unit 150 compares the positive detail intensity response I_{P} with the positive detail intensity response threshold I_{PT} (or compares an absolute value of the negative detail intensity response I_{N} with the negative detail intensity response threshold I_{NT}), and further in sub-step S630, the chrominance correction unit 150 converts the edge response of the pixel into the edge response weight. After sub-step S630, the chrominance correction unit 150 goes to sub-step S930 to check whether the hue H of the pixel falls in the hue range.

Referring to FIGS. 8, 9 and 10, if the edge response of the pixel is the positive detail intensity response I_{P}, the chrominance correction unit 150 further judges whether the hue H of the pixel falls in the hue range of between (H_{P}+ΔH_{P}) and (H_{P}−ΔH_{P}). If the edge response of the pixel is the negative detail intensity response I_{N}, the chrominance correction unit 150 further judges whether the hue H of the pixel falls in the hue range of between (H_{N}+ΔH_{N}) and (H_{N}−ΔH_{N}). If the hue H of the pixel falls in the hue range, the chrominance correction unit 150 goes to sub-step S640 to correct the original chrominance of the pixel.

In other words, when the hue H falls in the hue range, if the position weight W_{R} is greater than the position weight threshold W_{RT} and the edge response (I_{P} or I_{N}) is greater than the response threshold (I_{PT} or I_{NT}), in sub-step S940, the chrominance correction unit 150 corrects the original chrominance of the pixel by using a first normalized parameter W_{NORMAL1}, the edge response weight (W_{IP} or W_{IN}) and the position weight W_{R}. The first normalized parameter W_{NORMAL1} herein can be any real number. In implementations of the embodiment, the value of the first normalized parameter W_{NORMAL1} can be decided according to the real design requirements of products. If the edge response of the pixel is the positive detail intensity response I_{P}, in sub-step S940, the chrominance correction unit 150 can use Formulas 16 and 17 to calculate the new chroma component Cb′ and the new chroma component Cr′:

Cb′=Cb×W_{NORMAL1}÷(W_{R}+W_{IP}) Formula 16

Cr′=Cr×W_{NORMAL1}÷(W_{R}+W_{IP}) Formula 17

If the edge response of the pixel is the negative detail intensity response I_{N}, in sub-step S940, the chrominance correction unit 150 can use Formulas 18 and 19 to calculate the new chroma component Cb′ and the new chroma component Cr′:

Cb′=Cb×W_{NORMAL1}÷(W_{R}+W_{IN}) Formula 18

Cr′=Cr×W_{NORMAL1}÷(W_{R}+W_{IN}) Formula 19

When the hue H does not fall in the hue range, if the position weight W_{R} is greater than the position weight threshold W_{RT} and the edge response (I_{P} or I_{N}) is greater than the response threshold (I_{PT} or I_{NT}), in sub-step S940, the chrominance correction unit 150 corrects the original chrominance of the pixel by using a second normalized parameter W_{NORMAL2}, the edge response weight (W_{IP} or W_{IN}) and the position weight W_{R}. The second normalized parameter W_{NORMAL2} herein can be any real number not equal to the first normalized parameter W_{NORMAL1}. In implementations of the embodiment, the value of the second normalized parameter W_{NORMAL2} can be decided according to the real design requirements of products. If the edge response of the pixel is the positive detail intensity response I_{P}, in sub-step S950, the chrominance correction unit 150 can use Formulas 20 and 21 to calculate the new chroma component Cb′ and the new chroma component Cr′:

Cb′=Cb×W_{NORMAL2}÷(W_{R}+W_{IP}) Formula 20

Cr′=Cr×W_{NORMAL2}÷(W_{R}W_{IP}) Formula 21

If the edge response of the pixel is the negative detail intensity response I_{N}, in sub-step S950, the chrominance correction unit 150 can use Formulas 22 and 23 to calculate the new chroma component Cb′ and the new chroma component Cr′:

Cb′=Cb×W_{NORMAL2}÷(W_{R}+W_{IN}) Formula 22

Cr′=Cr×W_{NORMAL2}÷(W_{R}+W_{IN}) Formula 23

In summary, the chrominance correction unit 150 of the embodiments can correct the original chrominance (Cb and Cr) of the pixel by using the position weight W_{R} and the edge response weight (W_{IP} or W_{IN}). Thus, the embodiments can effectively eliminate/reduce the image chromatic aberration without revising the optical design of the set of lenses.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for eliminating chromatic aberration, comprising:
calculating a position weight of a pixel according to position of the pixel in an image; and
correcting original chrominance of the pixel by using the position weight.

2. The method for eliminating chromatic aberration as claimed in claim 1, wherein step of calculating the position weight of the pixel comprises:
calculating the position weight of the pixel according to relative distance between the pixel and center coordinates of the image.

3. The method for eliminating chromatic aberration as claimed in claim 2, wherein the operation of calculating the position weight of the pixel comprises:
calculating the position weight W_{R}=[(Xᵢ−X₀)²+(Yᵢ−Y₀)²]/[(Xₘₐₓ−X₀)²+(Yₘₐₓ−Y₀)²], wherein (X₀, Y₀) are the center coordinates of the image, (Xᵢ and Yᵢ) are coordinates of the pixel, Xₘₐₓ is maximal value among the X-axis of the image and Yₘₐₓ is maximal value among the Y-axis of the image.

4. The method for eliminating chromatic aberration as claimed in claim 1, wherein the operation of correcting original chrominance of the pixel comprises:
defining a position weight threshold;
comparing the position weight with the position weight threshold to obtain a comparison result; and
deciding whether to correct the original chrominance of the pixel according to the comparison result.

5. The method for eliminating chromatic aberration as claimed in claim 4, wherein the step of deciding whether to correct the original chrominance of the pixel according to the comparison result comprises:
if the position weight is greater than the position weight threshold, correcting the original chrominance of the pixel; and
if the position weight is less than the position weight threshold, not correcting the original chrominance of the pixel.

6. The method for eliminating chromatic aberration as claimed in claim 1, wherein the original chrominance of the pixel comprises a chroma component Cb and a chroma component Cr, and the operation of correcting the original chrominance of the pixel comprises:
calculating a new chroma component Cb′=Cb×W_{R}×W_{NORMAL}; and
calculating a new chroma component Cr′=Cr×W_{R}×W_{NORMAL};
wherein W_{R} is the position weight, and W_{NORMAL} is a normalized parameter.

7. The method for eliminating chromatic aberration as claimed in claim 1, wherein the original chrominance of the pixel comprises a chroma component Cb and a chroma component Cr, and the operation of correcting the original chrominance of the pixel comprises:
calculating a new chroma component Cb′=Cb×W_{NORMAL}÷W_{R}; and
calculating a new chroma component Cr′=Cr×W_{NORMAL}÷W_{R};
wherein W_{R} is the position weight, and W_{NORMAL} is a normalized parameter.

8. The method for eliminating chromatic aberration as claimed in claim 1, further comprising:
calculating an edge response of the pixel according to a luminance of the image;
wherein the operation of correcting the original chrominance of the pixel further uses the edge response and the position weight to correct the original chrominance of the pixel.

9. The method for eliminating chromatic aberration as claimed in claim 8, wherein the edge response is a positive detail intensity response or a negative detail intensity response, and the operation of calculating the edge response comprises:
performing a detail intensity calculation on the luminance of the image by using a filter, so as to obtain the positive detail intensity response or the negative detail intensity response of the pixel.

10. The method for eliminating chromatic aberration as claimed in claim 8, wherein the edge response is a positive detail intensity response or a negative detail intensity response, and the operation of correcting the original chrominance of the pixel comprises:
defining a position weight threshold, a positive detail intensity response threshold and a negative detail intensity response threshold;
if the edge response is the positive detail intensity response, converting the positive detail intensity response into a positive detail intensity response weight;
if the edge response is the negative detail intensity response, converting the negative detail intensity response into a negative detail intensity response weight;
comparing the position weight with the position weight threshold, and comparing the positive detail intensity response with the positive detail intensity response threshold or comparing an absolute value of the negative detail intensity response with the negative detail intensity response threshold; and
deciding whether to correct the original chrominance of the pixel according to the comparison results.

11. The method for eliminating chromatic aberration as claimed in claim 10, wherein the step of deciding whether to correct the original chrominance of the pixel according to the comparison results comprises:
if the position weight is greater than the position weight threshold, and the positive detail intensity response is greater than the positive detail intensity response threshold, correcting the original chrominance of the pixel; and
if the position weight is greater than the position weight threshold, and the absolute value of the negative detail intensity response is greater than the negative detail intensity response threshold, correcting the original chrominance of the pixel.

12. The method for eliminating chromatic aberration as claimed in claim 11, wherein the original chrominance of the pixel comprises a chroma component Cb and a chroma component Cr, and the operation of correcting the original chrominance of the pixel comprises:
calculating a new chroma component Cb′=Cb×(W_{R}+W_{IP})×W_{NORMAL}; and
calculating a new chroma component Cr′=Cr×(W_{R}+W_{IP})×W_{NORMAL};
wherein W_{R} is the position weigh, W_{IP} is the positive detail intensity response weight, and W_{NORMAL} is a normalized parameter.

13. The method for eliminating chromatic aberration as claimed in claim 11, wherein the original chrominance of the pixel comprises a chroma component Cb and a chroma component Cr, and the operation of correcting the original chrominance of the pixel comprises:
calculating a new chroma component Cb′=Cb×(W_{R}+W_{IN})×W_{NORMAL}; and
calculating a new chroma component Cr′=Cr×(W_{R}+W_{IN})×W_{NORMAL};
wherein W_{R} is the position weight, W_{IN} is the negative detail intensity response weight, and W_{NORMAL} is a normalized parameter.

14. The method for eliminating chromatic aberration as claimed in claim 11, wherein the original chrominance of the pixel comprises a chroma component Cb and a chroma component Cr, and the operation of correcting the original chrominance of the pixel comprises:
calculating a new chroma component Cb′=Cb×W_{NORMAL}÷(W_{R}+W_{IP}); and
calculating a new chroma component Cr′=Cr×W_{NORMAL}÷(W_{R}+W_{IP});
wherein W_{R} is the position weight, W_{IP} is the positive detail intensity response weight, and W_{NORMAL} is a normalized parameter.

15. The method for eliminating chromatic aberration as claimed in claim 11, wherein the original chrominance of the pixel comprises a chroma component Cb and a chroma component Cr, and the operation of correcting the original chrominance of the pixel comprises:
calculating a new chroma component Cb′=Cb×W_{NORMAL}÷(W_{R}+W_{IN}); and
calculating a new chroma component Cr′=Cr×W_{NORMAL}÷(W_{R}+W_{IN});
wherein W_{R} is the position weight, W_{IN} is the negative detail intensity response weight, and W_{NORMAL} is a normalized parameter.

16. The method for eliminating chromatic aberration as claimed in claim 1, further comprising:
calculating an edge response of the pixel according to a luminance of the image;
converting the edge response into a hue range; and
converting the chrominance of the pixel into a hue;
wherein the operation of correcting the original chrominance of the pixel further uses the edge response, the hue, the hue range and the position weight to correct the original chrominance of the pixel.

17. The method for eliminating chromatic aberration as claimed in claim 16, wherein the edge response is a positive detail intensity response or a negative detail intensity response, and the operation of calculating the edge response comprises:
performing a detail intensity calculation on the luminance of the image by using a filter, so as to obtain the positive detail intensity response or the negative detail intensity response of the pixel.

18. The method for eliminating chromatic aberration as claimed in claim 16, wherein the edge response is a positive detail intensity response or a negative detail intensity response, and the operation of correcting the original chrominance of the pixel comprises:
defining a position weight threshold, a positive detail intensity response threshold and a negative detail intensity response threshold;
if the edge response is the positive detail intensity response, converting the positive detail intensity response into a positive detail intensity response weight;
if the edge response is the negative detail intensity response, converting the negative detail intensity response into a negative detail intensity response weight;
comparing the position weight with the position weight threshold, comparing the positive detail intensity response with the positive detail intensity response threshold or comparing an absolute value of the negative detail intensity response with the negative detail intensity response threshold, and comparing the hue with the hue range; and
deciding whether to correct the original chrominance of the pixel according to the comparison results.

19. The method for eliminating chromatic aberration as claimed in claim 18, wherein the step of deciding whether to correct the original chrominance of the pixel according to the comparison results comprises:
correcting the original chrominance of the pixel by using a first normalized parameter, the positive detail intensity response weight and the position weight if the position weight is greater than the position weight threshold, the positive detail intensity response is greater than the positive detail intensity response threshold and the hue is within the hue range; and
correcting the original chrominance of the pixel by using the first normalized parameter, the negative detail intensity response weight and the position weight if the position weight is greater than the position weight threshold, the absolute value of the negative detail intensity response is greater than the negative detail intensity response threshold and the hue is within the hue range.

20. The method for eliminating chromatic aberration as claimed in claim 19, wherein the step of deciding whether to correct the original chrominance of the pixel according to the comparison results comprises:
correcting the original chrominance of the pixel by using a second normalized parameter, the positive detail intensity response weight and the position weight if the position weight is greater than the position weight threshold, the positive detail intensity response is greater than the positive detail intensity response threshold and the hue is not within the hue range; and
correcting the original chrominance of the pixel by using the second normalized parameter, the negative detail intensity response weight and the position weight if the position weight is greater than the position weight threshold, the absolute value of the negative detail intensity response is greater than the negative detail intensity response threshold and the hue is not within the hue range.

21. The method for eliminating chromatic aberration as claimed in claim 19, wherein the original chrominance of the pixel comprises a chroma component Cb and a chroma component Cr, and the operation of correcting the original chrominance of the pixel comprises:
calculating a new chroma component Cb′=Cb×W_{NORMAL1}÷(W_{R}+W_{IP}); and
calculating a new chroma component Cr′=Cr×W_{NORMAL1}÷(W_{R}+W_{IP});
wherein W_{R} is the position weigh, W_{IP} is the positive detail intensity response weight and W_{NORMAL1} is the first normalized parameter.

22. The method for eliminating chromatic aberration as claimed in claim 19, wherein the original chrominance of the pixel comprises a chroma component Cb and a chroma component Cr, and the operation of correcting the original chrominance of the pixel comprises:
calculating a new chroma component Cb′=Cb×W_{NORMAL1}÷(W_{R}+W_{IN}); and
calculating a new chroma component Cr′=Cr×W_{NORMAL1}÷(W_{R}+W_{IN});
wherein W_{R} is the position weight, W_{IN} is the negative detail intensity response weight and W_{NORMAL1} is the first normalized parameter.

23. The method for eliminating chromatic aberration as claimed in claim 20, wherein the original chrominance of the pixel comprises a chroma component Cb and a chroma component Cr, and the operation of correcting the original chrominance of the pixel comprises:
calculating a new chroma component Cb′=Cb×W_{NORMAL2}÷(W_{R}+W_{IP}); and
calculating a new chroma component Cr′=Cr×W_{NORMAL2}÷(W_{R}+W_{IP});
wherein W_{R} is the position weigh, W_{IP} is the positive detail intensity response weight and W_{NORMAL2} is the second normalized parameter.

24. The method for eliminating chromatic aberration as claimed in claim 20, wherein the original chrominance of the pixel comprises a chroma component Cb and a chroma component Cr, and the operation of correcting the original chrominance of the pixel comprises:
calculating a new chroma component Cb′=Cb×W_{NORMAL2}÷(W_{R}+W_{IN}); and
calculating a new chroma component Cr′=Cr×W_{NORMAL2}÷(W_{R}+W_{IN});
wherein W_{R} is the position weight, W_{IN} is the negative detail intensity response weight and W_{NORMAL2} is the second normalized parameter.

25. An apparatus for eliminating chromatic aberration, comprising:
a position weight calculation unit, receiving data of the pixel and calculating a position weight of the pixel according to position of the pixel in an image; and
a chrominance correction unit, coupled to the position weight calculation unit, wherein the chrominance correction unit corrects original chrominance of the pixel by using the position weight.

26. The apparatus for eliminating chromatic aberration as claimed in claim 25, wherein the position weight calculation unit calculates the position weight of the pixel according to relative distance between the pixel and center coordinates of the image.

27. The apparatus for eliminating chromatic aberration as claimed in claim 26, wherein the position weight calculation unit calculates the position weight W_{R}=[(Xᵢ−X₀)²+(Yᵢ−Y₀)²]/[Xₘₐₓ−X₀)²+(Yₘₐₓ−Y₀)²], wherein (X₀, Y₀) are the center coordinates of the image, (Xᵢ and Yᵢ) are coordinates of the pixel, Xₘₐₓ is maximal value among the X-axis of the image and Yₘₐₓ is maximal value among the Y-axis of the image.

28. The apparatus for eliminating chromatic aberration as claimed in claim 25, wherein the chrominance correction unit compares the position weight with a position weight threshold and decides whether to correct the original chrominance of the pixel according to the comparison result.

29. The apparatus for eliminating chromatic aberration as claimed in claim 25, further comprising:
an edge response unit, coupled to the chrominance correction unit, wherein the edge response unit receives the data of the pixel and calculates an edge response of the pixel according to a luminance of the image,
wherein the chrominance correction unit further uses the edge response and the position weight to correct the original chrominance of the pixel.

30. The apparatus for eliminating chromatic aberration as claimed in claim 29, wherein the edge response is a positive detail intensity response or a negative detail intensity response, and the chrominance correction unit defines a position weight threshold, a positive detail intensity response threshold and a negative detail intensity response threshold; the chrominance correction unit converts the positive detail intensity response into a positive detail intensity response weight if the edge response is the positive detail intensity response; the chrominance correction unit converts the negative detail intensity response into a negative detail intensity response weight if the edge response is the negative detail intensity response; the chrominance correction unit compares the position weight with the position weight threshold, and compares the positive detail intensity response with the positive detail intensity response threshold or compares an absolute value of the negative detail intensity response with the negative detail intensity response threshold; and the chrominance correction unit decides whether to correct the original chrominance of the pixel according to the comparison results.

31. The apparatus for eliminating chromatic aberration as claimed in claim 30, wherein
the chrominance correction unit corrects the original chrominance of the pixel if the position weight is greater than the position weight threshold and the positive detail intensity response is greater than the positive detail intensity response threshold; and the chrominance correction unit corrects the original chrominance of the pixel if the position weight is greater than the position weight threshold and the absolute value of the negative detail intensity response is greater than the negative detail intensity response threshold.

32. The apparatus for eliminating chromatic aberration as claimed in claim 25, further comprising:
an edge response unit, coupled to the chrominance correction unit, wherein the edge response unit receives the data of the pixel and calculates an edge response according to a luminance of the image;
a chrominance converting unit, receiving the data of the pixel and converts the chrominance of the pixel into a hue; and
a hue calculation unit, coupled to the chrominance converting unit and the chrominance correction unit, wherein the hue calculation unit converts the edge response into a hue range;
wherein the chrominance correction unit further uses the edge response, the hue, the hue range and the position weight to correct the original chrominance of the pixel.

33. The apparatus for eliminating chromatic aberration as claimed in claim 32, wherein the edge response is a positive detail intensity response or a negative detail intensity response, and the chrominance correction unit defines a position weight threshold, a positive detail intensity response threshold and a negative detail intensity response threshold; the chrominance correction unit converts the positive detail intensity response into a positive detail intensity response weight if the edge response is the positive detail intensity response; the chrominance correction unit converts the negative detail intensity response into a negative detail intensity response weight if the edge response is the negative detail intensity response; the chrominance correction unit compares the position weight with the position weight threshold, compares the positive detail intensity response with the positive detail intensity response threshold or compares an absolute value of the negative detail intensity response with the negative detail intensity response threshold, and compares the hue with the hue range; and the chrominance correction unit decides whether to correct the original chrominance of the pixel according to the comparison results.

34. The apparatus for eliminating chromatic aberration as claimed in claim 33, wherein the chrominance correction unit corrects the original chrominance of the pixel by using a first normalized parameter, the positive detail intensity response weight and the position weight if the position weight is greater than the position weight threshold, the positive detail intensity response is greater than the positive detail intensity response threshold and the hue is within the hue range; and the chrominance correction unit corrects the original chrominance of the pixel by using the first normalized parameter, the negative detail intensity response weight and the position weight if the position weight is greater than the position weight threshold, the absolute value of the negative detail intensity response is greater than the negative detail intensity response threshold and the hue is within the hue range.

35. The apparatus for eliminating chromatic aberration as claimed in claim 33, wherein
the chrominance correction unit corrects the original chrominance of the pixel by using a second normalized parameter, the positive detail intensity response weight and the position weight if the position weight is greater than the position weight threshold, the positive detail intensity response is greater than the positive detail intensity response threshold and the hue is not within the hue range; and
the chrominance correction unit corrects the original chrominance of the pixel by using the second normalized parameter, the negative detail intensity response weight and the position weight if the position weight is greater than the position weight threshold, the absolute value of the negative detail intensity response is greater than the negative detail intensity response threshold and the hue is not within the hue range.

36. A method for eliminating chromatic aberration, comprising:
calculating a position weight of a pixel according to relative distance between the pixel and center coordinates of an image;
calculating an edge response of the pixel according to a luminance of the image;
converting the edge response into a hue range; and
converting the chrominance of the pixel into a hue; and
correcting original chrominance of the pixel by using the edge response, the hue, the hue range and position weight.

37. The method for eliminating chromatic aberration as claimed in claim 36, wherein the edge response is a positive detail intensity response or a negative detail intensity response, and the operation of calculating the edge response comprises:
performing a detail intensity calculation on the luminance of the image by using a filter, so as to obtain the positive detail intensity response or the negative detail intensity response of the pixel.
